(19) United States
(12) Patent Application Publication
(10) Pub. No.: US 2025/0354590 A1
(43) Pub. Date: Nov. 20, 2025

(54) HYDRAULIC VEHICLE BRAKE

(71) Applicants: ZF Active Safety GmbH, Koblenz (DE); ZF Active Safety US Inc., Livonia, MI (US)

(72) Inventors: Joerg Knieper, Vallendar (DE); Kraig Gerber, Plymouth, MI (US); Marco Becker, Oberduerenbach (DE); Peter Maeurer, Koblenz (DE); Paul Wecker, Limburg (DE)

(21) Appl. No.: 19/284,810

(22) Filed: Jul. 30, 2025

Related U.S. Application Data
(62) Division of application No. 17/956,913, filed on Sep. 30, 2022.

(51) Int. Cl. F16D 65/18; F16D 121/04; F16D 125/06; F16D 125/08

(52) U.S. Cl. CPC F16D 65/18; F16D 2121/04; F16D 2125/06; F16D 2125/08

(57) ABSTRACT

In the case of a hydraulic vehicle brake, having a brake caliper (12), having a brake piston (16), having a receiving bore (14) for the brake piston (16), and having a brake piston seal (32) that acts between the brake caliper (12) and the brake piston (16), the brake piston seal (32) is designed as a composite part, with a composite of a base component (34) and a reinforcement insert (36). The reinforcement insert (36) provides the brake piston seal (32) with a degree of elasticity in an axial direction, whereby, after the brake piston (16) has been displaced in the direction of brake pads (22), the brake piston seal (32) displaces the brake piston (16) in the opposite direction.

### RELATED APPLICATIONS

This application is a divisional of U.S. application Ser. No. 17/956,913 filed 30 Sep. 2022, the entirety of which is hereby incorporated herein by reference.

### TECHNICAL FIELD

The invention relates to a hydraulic vehicle brake, having a brake caliper, having a brake piston, having a receiving bore for the brake piston, and having a brake piston seal that acts between the brake caliper and the brake piston.

### BACKGROUND

Such brake piston seals are commonly composed of elastomer material and are accommodated in a groove in the wall that defines the receiving bore. When the brake is actuated, the brake piston then moves relative to the brake piston seal, which is deformed within the groove owing to the friction between the seal and the brake piston. If the travel of the brake piston is greater than the travel that can be compensated exclusively by deformation of the brake piston seal, sliding of the brake piston along the brake piston seal occurs. If the braking operation is ended, the pressure in the chamber adjoining the brake piston falls abruptly, and it is the intention that the brake piston moves as quickly as possible back into the original position, that is to say into a position remote from the brake disk, in order to attain the optimum air gap. Here, by virtue of the fact that it seeks to move back into its non-deformed initial position, the deformed brake piston seal can assist this resetting operation of the brake piston.

### SUMMARY

It is an object of the invention to further improve this resetting effect that can be achieved by means of the brake piston seal.

This is achieved in the case of a hydraulic vehicle brake of the type mentioned in the introduction in that the brake piston seal is a composite part, with a composite of a base component and a reinforcement insert. The reinforcement insert provides the brake piston seal with such a degree of elasticity and increased relaxation force in an axial direction that, after the brake piston has been displaced in the direction of brake pads, the brake piston seal can displace the brake piston in the opposite direction.

The brake piston seal is consequently capable of fully overcoming the friction of the brake piston in the receiving bore if no positive pressure is present in the piston chamber that adjoins the piston.

The main direction of extent of the reinforcement insert runs, in a cross section through the brake piston seal, preferably in a radial direction of the brake piston seal, that is to say the major part (over 50% of the total length) of the reinforcement insert runs in a range of at most ±30° with respect to the radial direction.

This resetting force has further advantages, because it also acts in the opposite direction. For example, in the event of a high-speed cornering manoeuvre, the forces acting on the brake disk, and the associated lateral deflection of the latter, can cause a brake piston situated at the outside of the corner to be displaced deeper into the receiving bore. If the vehicle travels through right-hand and left-hand corners in succession, it is even the case that both brake pistons are displaced deeper into their receiving bores. This however then increases the air gap, such that the pedal travel is increased, which is disadvantageous with regard to the reaction time of the vehicle brake and the pedal feel. The brake piston seal is also capable of displacing the brake piston, after the cornering manoeuvre, back into the desired initial position close to the brake disk. The reinforcement insert consequently achieves higher, predictable, resetting forces (also referred to as piston retraction forces), which can also be referred to as better knockback behaviour, than in the case of previous brake piston seals.

The reinforcement insert is partially or fully embedded into the base component. In the case of partial embedding, a part of the reinforcement insert projects out of the base component. The reinforcement insert need not be composed of one part; the reinforcement insert may rather be formed from multiple parts.

In any case, the reinforcement insert is however a prefabricated part, or multiple prefabricated parts are provided, which is/are subsequently embedded into the base component in order to stiffen the brake piston seal.

The optimum compromise between high resetting force/piston retraction force and long adjustment and resetting travel is obtained if the reinforcement insert is subjected to bending loading in the event of a relative movement between brake piston and brake caliper.

The base component of the composite may be an elastomer, in particular EPDM (ethylene propylene diene monomer), which is very highly suitable for the above-stated purposes.

The reinforcement insert may be formed by numerous fibres, in particular fibres with a stiffness exceeding that of the base component. Such fibres are for example carbon fibres and/or glass fibres. If these are distributed very uniformly in the base component, the result is a very harmonious and effectively predeterminable force-travel characteristic during the compression and relaxation of the brake piston seal.

As an alternative to this, the reinforcement insert may be formed by a prefabricated spring element composed of metal or plastic. Said spring element may be fully embedded into the base component, for example in the form of a disk which runs with its flat sides approximately or entirely in a radial direction.

The disk may also have radial slots or radial recesses in order to increase its flexural elasticity in an axial direction. Thus, during the production of the brake piston seal, the reinforcement insert is fully encapsulated by the base component during the insert moulding process.

The brake piston seal is in particular, as already mentioned, accommodated in a groove in the receiving bore.

Another embodiment provides for the seal to be composed of multiple portions. The spring element itself is a bellows which is embedded at one end into an elastomer ring, which in turn is accommodated in a groove in the piston. At the other end, the bellows is embedded into an elastomer ring that is seated in a recess on the brake caliper. Said brake piston seal thus bridges and closes the gap already at the start of the receiving bore, more specifically before the receiving bore. In this case, the brake piston seal is seated specifically at an end of the brake piston close to the brake pad.

It is additionally advantageous here if a further piston seal, which is composed only of an elastomer, is seated radially between the brake piston and the wall that defines the receiving bore. This means that this seal is then formed without a reinforcement structure. This second seal is in particular an O-ring or a quad ring or the like.

One variant of the invention provides that, in the event of a relative movement between the brake piston and brake caliper of up to 1.5 mm, exclusively static friction prevails between the brake piston seal and the brake piston in the region of the contact area. This means that, up to this point, the brake piston does not slide along on the brake piston seal. The adjustment of the brake piston can then be compensated exclusively by a relaxation of the brake piston seal upon the release of the brake.

The brake piston seal is preferably configured such that, after the brake piston has been displaced with a maximum displacement travel, for example in the direction of the brake pads or deeper into the receiving bore, said brake piston seal exerts a resetting force of at least 250 N and at most 900 N on the brake piston. This value range has proven to be optimal because, otherwise, the brake piston seal would on the one hand oppose the displacement of the brake piston with too great a resistance during braking, and said brake piston seal would on the other hand generate relatively little resetting force.

### BRIEF DESCRIPTION OF THE DRAWINGS

Further features and advantages of the invention will emerge from the following description and from the subsequent drawings, to which reference is made.

In the drawings:

FIG. 1 shows a schematic cross-sectional view through a part of a hydraulic vehicle brake according to the invention,

FIG. 2 shows a schematic sectional view through a first variant of the brake piston seal that can be used in the vehicle brake according to the invention, in an installed state,

FIG. 3 shows a schematic sectional view through a second variant of the brake piston seal that can be used in the vehicle brake according to the invention, in an installed state,

FIG. 4 shows a force-travel diagram illustrating the resetting force exerted by the brake piston seal as a function of the adjustment travel of the brake piston,

FIG. 5 shows a schematic sectional view through a third variant of the brake piston seal that can be used in the vehicle brake according to the invention, in an installed state,

FIG. 6 shows a schematic sectional view through a fourth variant of the brake piston seal that can be used in the vehicle brake according to the invention, in an installed state, and

FIG. 7 shows a force-travel diagram showing the resetting force of a brake piston seal according to FIG. 5 both during cornering manoeuvres and during braking.

### DESCRIPTION

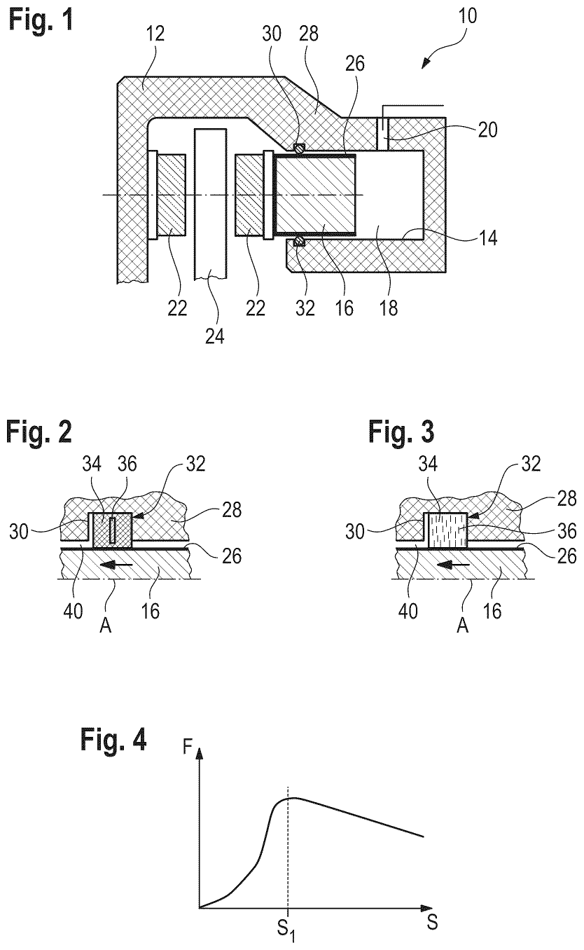

FIG. 1 illustrates a hydraulic vehicle brake 10, the hydraulic circuit of which has been omitted for the sake of simplicity. The vehicle brake 10 comprises a brake caliper 12, which is designed as an axially displaceable caliper.

In the brake caliper 12 or a part attached thereto, a receiving bore 14 is provided in which a brake piston 16 is mounted in axially displaceable fashion.

A piston chamber 18 in the brake caliper 12 is filled with hydraulic fluid via a bore 20. The question of whether additional inlet bores or additional outlet bores are provided is not of importance for the essential part of the vehicle brake discussed below.

Two brake pads 22 that are mounted directly or indirectly on the brake caliper 12 can be moved towards one another by means of the brake piston 16 in order for a brake disk 24, which is present between the brake pads 22, to be clamped between said brake pads and for a braking operation to thus be effected.

Between an outer circumferential surface 26 of the brake piston 16 and the inside of the receiving bore 14, in a wall 28 that defines the receiving bore 14, a groove 30 is provided for receiving an annular brake piston seal 32.

This brake piston seal 32 acts between the brake caliper 12 and the brake piston 16 and prevents an escape of hydraulic fluid from the piston chamber 18 and furthermore an ingress of liquid or contaminants from the surroundings into the piston chamber 18 and into a gap 40 between the brake piston 16 and the inside of the wall 28 in the region of the receiving bore 14.

FIG. 2 shows a first variant of the brake piston seal 32.

The brake piston seal 32 is not, as in the prior art, formed purely from an elastomer and so as to be as homogeneous as possible, with regard to its material, over the entire volume, but is rather a composite part with an elastomer base component 34, for example EPDM, and a reinforcement insert 36 which is embedded in said base component and which in the present case is a metal or plastics annular disk.

The flexural stiffness of the material of the reinforcement insert 36 in an axial direction is preferably higher than that of the base component 34.

In this embodiment, the reinforcement insert 36 is accommodated entirely in the base component 34, that is to say is surrounded by the latter on all sides.

The annular disk may optionally be interrupted such that only individual, mutually spaced-apart segments are provided, or the annular disk may, likewise optionally, be provided, proceeding from the radial inner edge thereof, with slot-like indentations in order to have greater elasticity imparted thereto.

The orientation of the reinforcement insert 36, that is to say its main direction of extent, is in a radial direction with respect to the central axis A of the brake piston 16.

In the variant according to FIG. 3, a reinforcement insert 36 composed of fibres, in particular carbon and/or glass fibres, the stiffness of which exceeds that of the base component 34, is embedded into the base component 34. Owing to the orientation of the fibres predominantly in a radial direction, this reinforcement insert 36 also has a main direction of extent in a radial direction.

In very general terms, the reinforcement insert 36 provides the brake piston seal 32 with higher flexural stiffness in an axial direction.

An explanation will be given below as to how the brake piston seal 32 ensures improved resetting of the brake piston 16 after a braking operation or a cornering manoeuvre.

FIGS. 2 and 3 illustrate the position of the brake piston seal 32 in a non-actuated state of the vehicle brake 10, in which a desired optimum air gap is present.

Here, the groove 30 is illustrated with an exaggerated width in an axial direction, such that, to the left of the brake piston seal 32, there is a gap which is not present, or not imperatively present, in practice. This is intended merely to symbolize that the brake piston 16 has not yet been deployed.

When a pressure is generated in the piston chamber 18, the brake piston 16 is displaced in the direction of the brake disk 24. Here, owing to the static friction between the outer circumferential surface 26 of the brake piston 16 and the brake piston seal 32, the brake piston seal 32 is driven along in the direction of the arrow in FIGS. 2 and 3 and is thus pressed against, or pressed with greater intensity against, the left-hand side wall of the groove 30, so as to be compressed and slightly bent owing to the gap 40 that is present between the wall 28 and the outer circumferential surface 26.

After the brake pads 22 have been moved together and have clamped the brake disk 24 between them and have thus effected a braking operation, the pressure in the piston chamber 18 is reduced relatively abruptly, by way of corresponding switching in the hydraulic circuit, after the end of the braking operation.

The result is a relaxation of the elastic deformation of all parts that are subjected to pressure and force loading, in particular of the brake caliper 12, which occurs when the high brake pressure is applied. This leads to a relaxation of these parts in the absence of the pressure. The previously loaded parts move back into their initial position, wherein it is important for the predetermined air gap to be generated.

The compressed and bent brake piston seals 32 likewise seek to return into their initial situation. Owing to the static friction on the brake piston 16 and the integrated reinforcement insert 36, the brake piston seals 32 ensure that the brake piston 16 is pulled back into its initial position counter to the direction of the arrow in FIGS. 2 and 3.

The force that the brake piston seals 32 impart here is sufficient, in the absence of positive pressure in the piston chamber 18, to implement a movement of the brake piston 16 counter to the brake application direction.

Optionally, the brake piston seals 32 may exert a resetting force of at least 250 N and at most 900 N on the brake piston 16 in the resetting direction.

The design of the brake piston seals 32 with regard to the air gap and the size of the groove 30 is selected such that, in the event of a relative movement between brake piston 16 and brake caliper 12 in the application direction of the brake as far as an air gap of at most 0.5 mm, exclusively static friction prevails between the brake piston seal 32 and the brake piston 16, that is to say the brake piston 16 does not slide along on the outer circumferential surface 26. This ensures that the brake piston seal 32 can exert a resetting force over the entire application travel of the brake.

Furthermore, the design of the brake piston seals 32 with regard to the knockback is selected such that, in the event of a relative movement between brake piston 16 and brake caliper 12 away from the brake disk 24 as far as a piston retraction travel of at most 1.5 mm, exclusively static friction prevails between the brake piston seal 32 and the brake piston 16, that is to say the brake piston 16 does not slide along on the outer circumferential surface 26. This ensures that the brake piston seal 32 can exert a piston retraction force over the entire application travel of the brake.

This resetting movement functions in exactly the same way in the opposite direction if, owing to a cornering manoeuvre, the brake disk 24 pushes against the brake pads 22 and thus pushes the brake piston 16 deeper into the receiving bore 14, such that the air gap is increased.

FIG. 4 illustrates the piston retraction force versus the travel of the brake, more specifically of the brake piston 16. At the point of intersection of the axes, the brake piston 16 is in its desired initial position with optimum air gap and without pressure loading.

In the initial phase of the movement of the brake piston 16 by the brake disk 24 during a cornering manoeuvre, the resetting force initially increases slowly, before then increasing intensely when the reinforcement insert 36 is compressed and bent. The point of highest force is then achieved when no sliding movement has quite yet occurred between brake piston 16 and brake piston seal 32. If the brake piston 16 however thereafter slips slightly, or slips further, the resetting force progressively decreases.

As can be seen, the resetting force has a progressive characteristic as far as the highest point on the Y axis, up to which point the brake piston 16 is also normally only retracted. This highest point is reached at the travel point S1, which corresponds to the piston retraction travel of up to 1.5 mm.

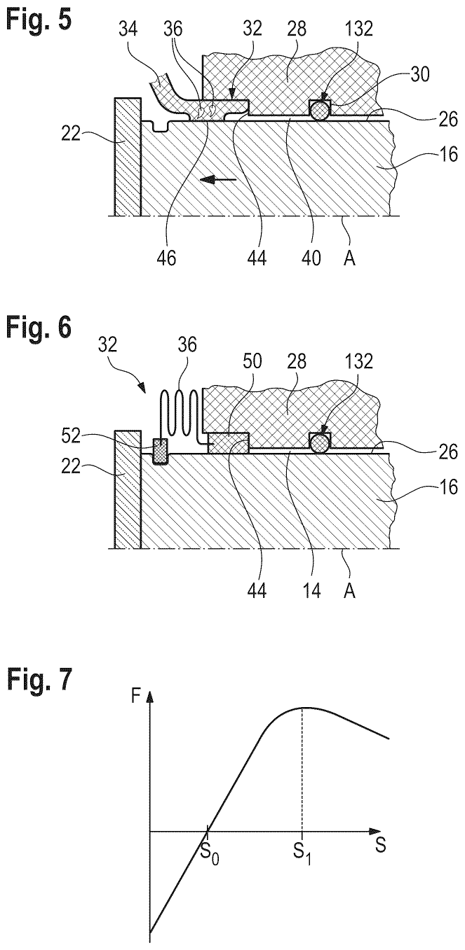

The embodiment according to FIG. 5 provides two brake piston seals 32 and 132.

The brake piston seal 132 is, like the brake piston seals 32 shown previously in FIGS. 2 and 3, positioned in a groove 30 in the wall 28. This brake piston seal 132 is however formed only from an elastomer base component, for example an O-ring or a quad ring. It does not comprise any reinforcement insert.

However, a brake piston seal 32 is provided at that end of the wall 28 which is close to the brake pad 22. By means of this brake piston seal 32, the gap 40 is sealed off already at the start of the receiving bore 14, because the brake piston seal 32 is seated in a pressed-in manner in a recess 44, which is open at an end side, in the wall 28 and makes contact with the outer circumferential surface 26 by way of a type of lip 46.

Multiple reinforcement inserts 36 in the form of slightly oblique or exactly radially running rings composed of metal or plastic extend in the base component 34, in which the reinforcement inserts 36 are fully embedded. More specifically, the reinforcement inserts 36 extend to and into the lip 46.

An obliquity of the reinforcement inserts 36 in the initial position (no brake pressure, straight-ahead travel) means that, in the event of excessive retraction of the brake piston 16 into the receiving bore 14 during cornering manoeuvres, said reinforcement inserts can stand upright and become jammed, which means that the annular reinforcement inserts 36 then lie in the radial plane or close the said radial plane such that a self-locking function arises, preventing a further backward movement of the brake piston 16 that would then result in an excessively large air gap.

During normal operation, however, the reinforcement insert 36 assists the backward movement of the brake piston in order to achieve the desired air gap, as in the embodiments according to FIGS. 2 and 3.

In the variant according to FIG. 6, the brake piston 32 is composed of multiple base components. Here, too, the brake piston seal 32 is positioned at the end of the brake piston 16 close to the brake pad 22, as in FIG. 5.

A first elastomer ring 50 as a first base component is seated, likewise with an interference fit, in a recess 44 that adjoins the end side of the wall 28. Said ring 50 should not make contact with the outer circumferential surface 26. A reinforcement insert 36 in the form of a bellows-like spring element is embedded, at one of its ends (as seen in cross section), in the ring 50 and, at the opposite end, in a second elastomer ring 52 as a second base component, which is seated in a groove in the brake piston 16. Said groove is always situated outside the receiving bore 14.

The main direction of extent of said bellows is likewise the radial direction, as can be clearly seen from FIG. 6.

Movement of the brake piston 16 during the actuation of the brake causes the bellows to be stretched slightly, whereby the reinforcement insert 36 is bent in certain portions, and the later resetting force is generated. Here, too, the brake piston seal 32 is present to close off the entrance of the receiving bore 14 with respect to the surroundings.

During cornering manoeuvres, the bellows is correspondingly compressed.

In general, it is the case for all variants, and also variants that are not shown, that a resetting force with a progressive characteristic is advantageous.

The base component 34, which is also used in the rings 50, 52, should be composed of elastomer, for example EPDM.

FIG. 7 finally shows the resetting force of the brake piston seal 32 according to FIG. 5.

At the travel point SO, the brake piston 16 is in its initial position, that is to say without pressure loading and with an optimum air gap.

If the spacing is then reduced during braking (that is to say if one moves to the left on the X axis, closer to the point of intersection of the axes), the generated resetting force increases, but merely has a negative sign.

In the opposite direction, during cornering manoeuvres, the movement of the brake piston 16 deeper into the receiving bore 14 likewise leads to an increase in force (with a positive sign) up to the travel point S1, at which the brake piston 16 then slides along on the lip 46 and loses its purely static friction.

1. Hydraulic vehicle brake, having a brake caliper (12), having a brake piston (16), having a receiving bore (14) for the brake piston (16), and having a brake piston seal (32) that acts between the brake caliper (12) and the brake piston (16),
wherein the brake piston seal (32) is a composite part, with a composite of a base component (34) and a reinforcement insert (36), the reinforcement insert (36) being formed by numerous fibres, in particular fibres with a stiffness exceeding that of the base component (34), and
wherein the reinforcement insert (36) provides the brake piston seal (32) with such a degree of elasticity in an axial direction that, after the brake piston (16) has been displaced in the direction of brake pads (22), the brake piston seal (32) displaces the brake piston (16) in the opposite direction.

2. Hydraulic vehicle brake according to claim 1, wherein the reinforcement insert (36) is embedded, in particular entirely, into the base component (34).

3. Hydraulic vehicle brake according to claim 1, wherein the reinforcement insert (36) is subjected to bending loading in the event of a relative movement between brake piston (16) and brake caliper (12).

4. Hydraulic vehicle brake according to claim 1, wherein the base component (34) of the composite is an elastomer, in particular EPDM (ethylene propylene diene monomer).

5. Hydraulic vehicle brake according to claim 1, wherein the fibres are carbon fibres and/or glass fibres.

6. Hydraulic vehicle brake according to claim 1, wherein, in the event of a relative movement between the brake piston (16) and brake caliper (12) of up to 1.5 mm, exclusively static friction prevails between the brake piston seal (32) and the brake piston (16) in the region of the contact area between the brake piston seal (32) and brake piston (16).

7. Hydraulic vehicle brake according to claim 1, wherein the brake piston seal (32) is configured such that, after the brake piston (16) has been displaced, the brake piston seal exerts a resetting force with a progressive characteristic on the brake piston (16).

8. Hydraulic vehicle brake according to claim 1, wherein, in the event of the brake piston (16) being displaced to a maximum extent, the brake piston seal (32) exerts a resetting force of at least 250 N and at most 900 N on the brake piston (16).
